(19) United States
(12) Patent Application Publication
(10) Pub. No.: US 2017/0017489 A1
(43) Pub. Date: Jan. 19, 2017

(54) SEMICONDUCTOR DEVICE

(71) Applicant: Renesas Electronics Corporation, Tokyo (JP)

(72) Inventor: Masayuki KIMURA, Tokyo (JP)

(21) Appl. No.: 15/154,753

(22) Filed: May 13, 2016

(30) Foreign Application Priority Data
Jul. 16, 2015 (JP) 2015-142265

(51) Int. Cl. G06F 9/30

(52) U.S. Cl. CPC G06F 9/30036; G06F 9/30101; G06F 9/30021

(57) ABSTRACT

A semiconductor device includes a central processing unit capable of executing a vector instruction. The vector instruction is an instruction to calculate a vector register for every element, combine the additional information based on the calculated result for every element, shift the contents of a register different from the vector register to right or left, insert the combined additional information in an empty portion resulting from the shift, and accumulate the additional information in the register.

### CROSS-REFERENCE TO RELATED APPLICATIONS

The disclosure of Japanese Patent Application No. 2015-142265 filed on Jul. 16, 2015 including the specification, drawings and abstract is incorporated herein by reference in its entirety.

### BACKGROUND

This disclosure relates to a semiconductor device, and for example, it can be applied to a semiconductor device containing a CPU for executing a vector instruction.

There is a Single Instruction Multiple Data (SIMD) instruction (for, example, US Patent Publication Laid-Open No. 2008/0077773) for comparing data elements of two packed operands to process character strings. The SIMD instruction is also called a vector instruction and in this disclosure, it is referred to as the vector instruction.

### SUMMARY

When the size of array exceeds the number of elements handled by one vector instruction, in data search in the array, it is necessary to interpose a scalar instruction between the vector instruction, which makes it difficult to use the vector instruction efficiently.

Other problems and novel characteristics will be apparent from the description of the specification and the attached drawings.

Of the disclosure, the outline of the typical one will be described briefly as follows. In short, the vector instruction is to create additional information different from the operation result and to accumulate the additional information in a different register from the additional information.

According to the invention, the vector instruction can be efficiently used.

### BRIEF DESCRIPTION OF THE DRAWINGS

FIG. 1 is a block diagram for use in describing a vector instruction according to one embodiment.

FIG. 2 is a block diagram for use in describing a semiconductor device according to a first example

FIG. 3 is a block diagram for use in describing a vector instruction according to the first example.

FIG. 4 is a view for use in describing an insertion operation.

FIG. 5 is a view for use in describing an insertion operation.

FIG. 6 is a block diagram for use in describing an operation of the exclusive circuit in FIG. 3.

FIG. 7 is a block diagram for use in describing a vector instruction according to a comparison example.

FIG. 8 is a view for use in describing a comparison operation in continuous arrays by using the vector instruction according to the comparison example.

FIG. 9 is a view for use in describing a comparison operation in the continuous arrays by using the vector instruction according to the first example.

FIG. 10 is a block diagram for use in describing the vector instruction according to a second example.

FIG. 11 is a block diagram for use in describing an exclusive register in FIG. 10.

FIG. 12 is a block diagram for use in describing the structure of an instruction for executing an algorithm in the case of using the vector instruction according to the comparison example.

FIG. 13 is a block diagram for use in describing the execution process in the case of executing the algorithm using the vector instruction according to the comparison example.

FIG. 14 is a block diagram for use in describing the structure of an instruction for executing an algorithm in the case of using the vector instruction according to the second example.

FIG. 15 is a block diagram for use in describing the execution process in the case of executing the algorithm using the vector instruction according to the second example.

### DETAILED DESCRIPTION

Hereinafter, embodiments or examples will be described using the drawings. In the following description, the same codes are attached to the same components and their repeated description may be omitted.

### Embodiment

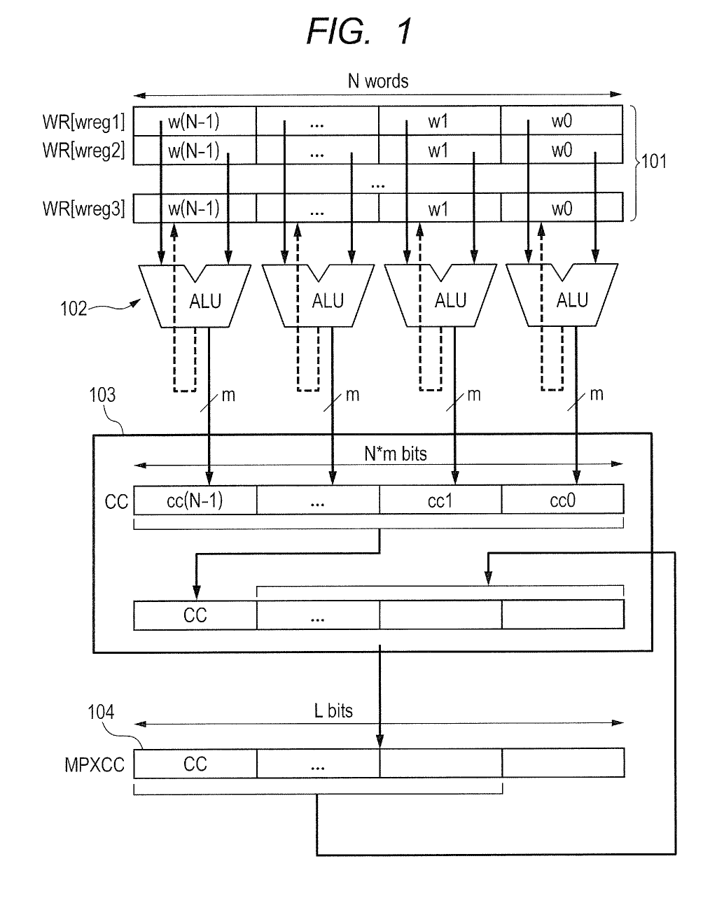

FIG. 1 is a view for use in describing a vector instruction according to one embodiment. The vector instruction according to the embodiment is an instruction for carrying out an operation in a vector register, to calculate N pieces of data at once. At this point, the vector instruction generates N pieces of operation result and depending on the operation result, it also generates information for supporting the operation result (additional information such as a flag of the operation result and a comparison result).

The vector instruction according to the embodiment is an instruction to calculate the contents of a first vector register (WR[wreg1]) and the contents of a second vector register (WR[wreg2]), store the operation result into a third vector register (WR[wreg3]), generate additional information (CC) separately from the operation result, and accumulate the above information in a register (MPXCC) 104 for storing the additional information different from the vector register (WR) 101. The operation result does not always have to be stored in the vector register (WR) 101. Further, the operation result may not be stored in the third vector register (WR[wreg3]) but may be stored in the first vector register (WR[wreg1]) or the second vector register (WR[wreg2]). Each vector register (WR) 101 stores N pieces of elements (w0, w1, . . . , w(N−1)).

A data processor of executing the vector instruction according to the embodiment includes a vector register (WR) 101, N pieces of arithmetic units (ALU) 102 for calculating the contents of the vector register (WR) 101, an exclusive circuit 103, and a register (MPXCC) 104. The respective N arithmetic units (ALU) 102 generate respective additional information elements (cc0, cc1, . . . , cc (N−1)). The additional information elements (cc0, cc1, . . . , cc(N−1)) are combined by the exclusive circuit 103 as the additional information (CC). Combination means that some bits or bit strings are combined together as one bit string. When each of the additional information elements (cc0, cc1, . . . , cc(N−1)) is of m bits, the additional information (CC) becomes N*m. bits. The exclusive circuit 103 shifts the existing contents of the register (MPXCC) 104 to right or left and then, inserts the additional information (CC) in an empty bit region. In other words, the additional information (CC) stored in the register (MPXCC) is not to be overwritten to the whole contents of the register (MPXCC) 104. When the width of the register (MPXCC) 104 is defined as L bits, the register (MPXCC) 104 can store L/(N*m) pieces of the additional information (CC). The vector instruction according to the embodiment, even when exceeding the number of the data operable by one instruction, can accumulate the additional information into the register, only by continuous execution of the vector instructions.

Hereinafter, the register for storing the additional information (CC) is referred to as an additional information storing register (MPXCC), and for the MPXCC, the general register for use in the normal arithmetic operation may be used or the exclusive register may be used. The data of the operation result is various; for example, 8 bits to 64 bits, depending on the type of the vector instruction. The additional information of m bits generated in every N pieces of operation is generally 2 to 3 bits in the case of flag and 1 bit in the case of the result of the comparison operation.

### First Example

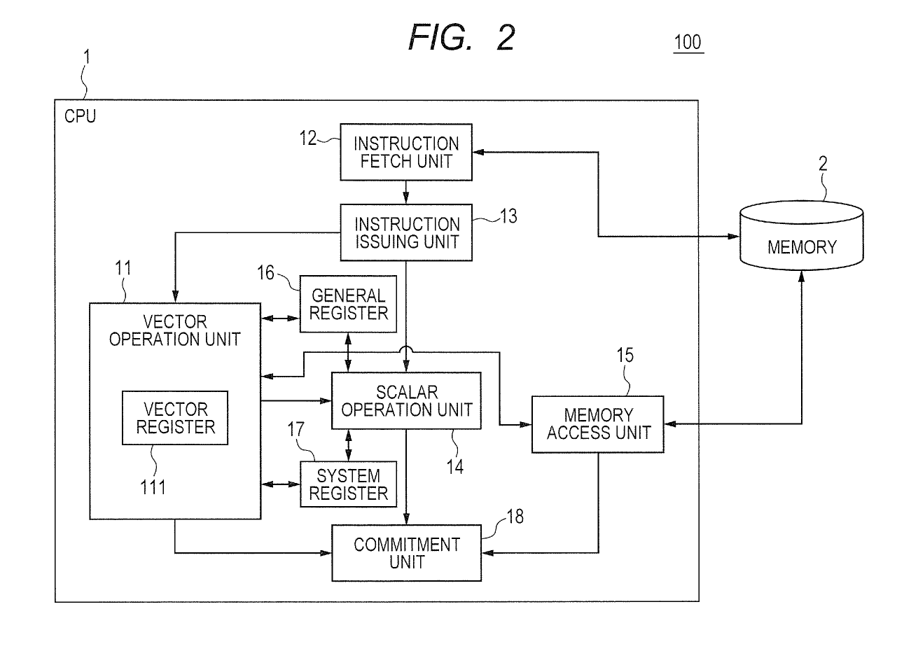

FIG. 2 is a block diagram showing the structure of a semiconductor device according to a first example. A semiconductor device 100 according to the first example includes a central processing unit (CPU) 1 as a data processor and a storing device (memory) 2 on one semiconductor substrate. The CPU 1 holds a unit capable of executing a vector operation (SIMD operation). An instruction fetch unit 12 fetches an instruction from the memory 2, an instruction issuing unit 13 passes the fetched instruction to a vector operation unit 11, and the vector operation unit 11 executes the instruction. The CPU 1 includes a scalar operation unit 14 for executing a standard instruction and a memory access unit 15 for gaining access to the memory 2, other than the vector operation unit 11. The vector operation unit 11 is coupled to the scalar operation unit 14 and the memory access unit 15, to ask them for data transmission and reception and deputy of memory access. The memory 2 stores the vector instruction executed by the vector operation unit 11 and scalar instruction executed by the scalar operation unit 14. An instruction using the vector register 111 is referred to as a vector instruction and an instruction using the general register 16 is referred to as a scalar instruction. Here, the general register 16 includes, for example, 32 units of registers each having 32 bits width (GR[0] to GR[31]).

The CPU 1 includes a system register 17 for managing the control information of the CPU 1 and the access information, in addition to the general register 16 for storing the result on the way of the operation. The vector operation unit 11 also has the system register 17, generally keeping the setting information of the vector operation and the contents of flag. The general instruction can gain access to the general register 16 but cannot gain access to the system register 17. A system register access instruction can be used to transfer the contents of the general register 16 to the system register 17 and transfer the values of the system register 17 to the general register 16. The memory 2 is formed by a volatile memory such as cache memory or a non-volatile memory electrically rewritable such as a flash memory.

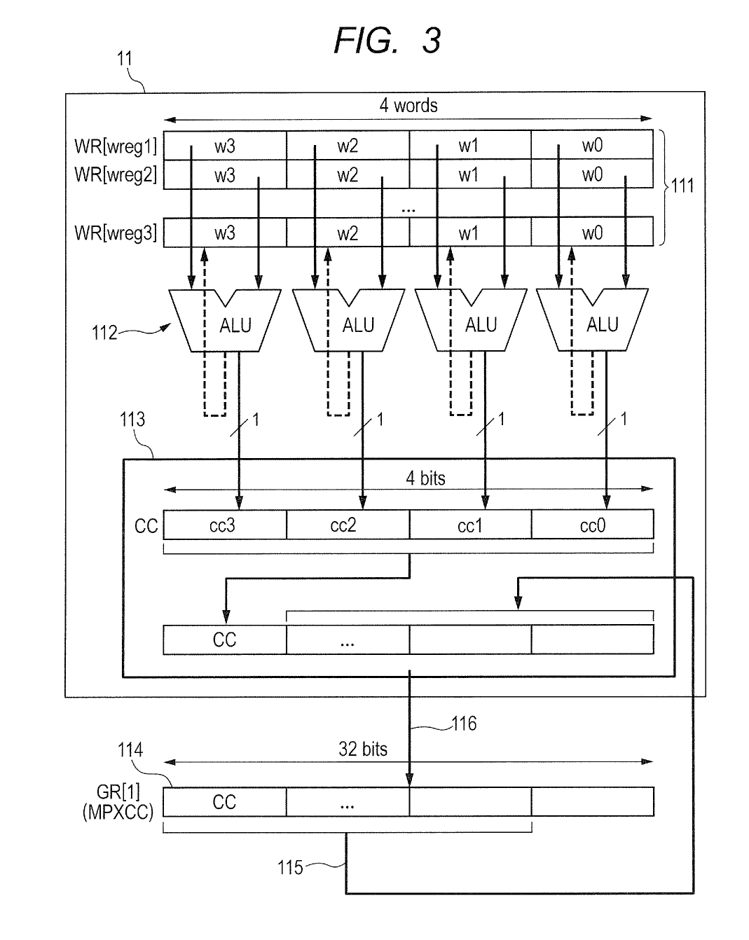

FIG. 3 is a block diagram for use in describing the function of the vector instruction according to the first example. The vector operation unit 11 includes vector registers (WR) 111, arithmetic units (ALU) 112, and a circuit 113. Each of the vector registers (WR) 111 stores four elements (w0, w1, w2, w3). Therefore, the vector operation units 11 are provided with four arithmetic units (ALU) 112 for calculating the contents of the vector registers (WR) 111. The four arithmetic units (ALU) 112 respectively generate additional information elements (cc0, cc1, cc2, cc3). The additional information elements (cc0, cc1, cc2, cc3) are combined by the exclusive circuit 113, as the additional information (CC). The additional information (CC) is of 4 bits. The exclusive circuit 113 shifts the existing contents of the general register (GR[1]) 114 that is the MPXCC to right or left, and then inserts the additional information (CC) into an empty bit region. In other words, the additional information (CC) stored in the general register (GR[1]) 114 is not all overwritten to the contents of the general register (GR[1]) 114. When the width of the general register (GR[1]) 114 is defined as 32 bits, 32/4=8 pieces of the additional information (CC) can be stored in the general register (GR[1]) 114. In this example, although the GR[1] of the general registers is used as the MPXCC, it is not restricted to this but any register may be used as far as it is the general register.

The vector instruction according to the first example is an instruction to execute an operation using two vector registers, write the operation result into the vector register, and output such additional information that supports the operation result, depending on the operation result; for example, the instruction as follows.

cmp1. N order, cond, wreg1, wreg2, wreg3

The vector instruction according to the example compares the contents of the vector register (wreg1) with the contents of the vector register (wreg2), stores the result into the vector register (wreg3) and simultaneously stores the additional information into the general register (GR[1]) 114 implicitly specified. The vector instruction according to the example stores 0 into the wreg3 in the case of disagreement as the comparison result and stores 1 in the case of agreement as the comparison result. The wreg1, wreg2, and wreg3 are of 128 bit length and divided into N(=1, 2, 4) pieces of data. In the case of N=1, the least significant word w0 in the vector register is used, in the case of N=2, two lower words w1 and w0 in the vector register are used, and in the case of N=4, the whole w3, w2, w1, and w0 in the vector register are used. One word has 32 bits and each of w3, w2, w1, and w0 has 32 bits. As the comparison result, the vector instruction according to the example generates the additional information (CC) of N bit and inserts the same information into the general register (GR[1]) 114. The additional information (CC) of N bit is inserted into an empty portion resulting from shifting the values of the general register (GR[1]) to right or left by N bits. At this point, depending on the “order”, it is determined whether the additional information (CC) is inserted from the high order (rightward shift) or from the low order (leftward shift) in the general register (GR[1]). This enables search from the high order address and search from the low order address. FIG. 3 shows the case of shifting rightward. The “cond” specifies the setting condition of the additional information (=, >, <, ≧, ≦, and ≠).

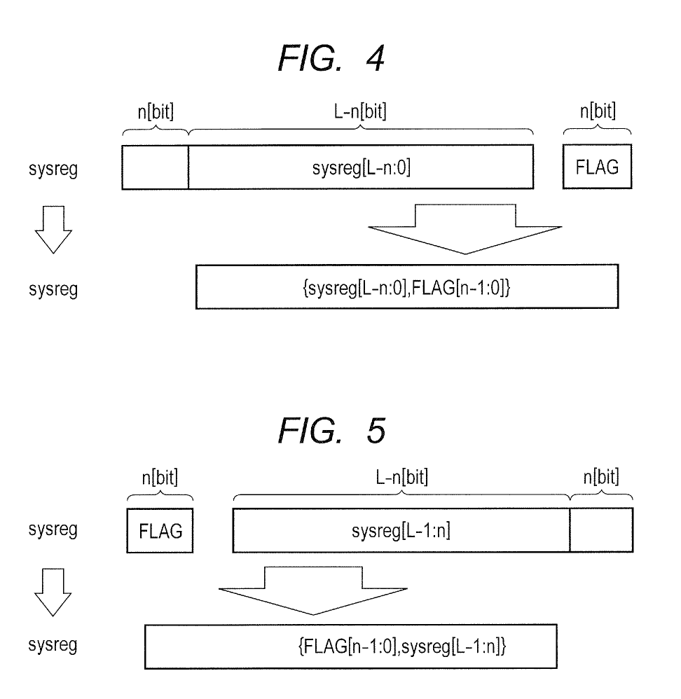

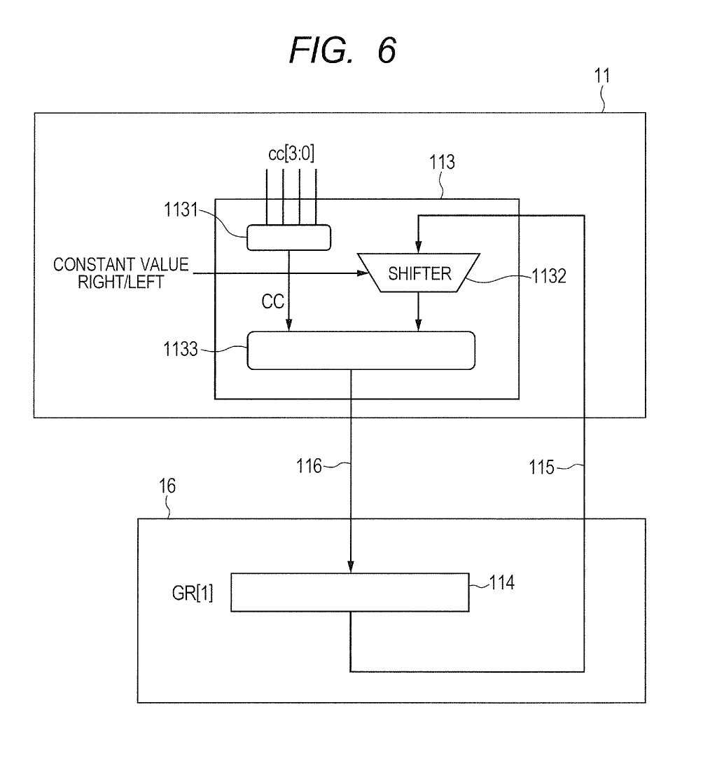

FIGS. 4 and 5 are views for use in describing the insertion operation. FIG. 4 is in the case of inserting data from the low order in the register and FIG. 5 is in the case of inserting data from the high order in the register. In the case of inserting the data of n bits into the register (sysreg (GR[1])) of L bits, the concrete operation is described in the Verilog-HDL language as follows.

In the case of inserting data from the low order in the register (FIG. 4):

sysreg[L−1: 0]<={sysreg[L−n: 0], FLAG[n−1: 0]}

In the case of inserting data from the high order in the register (FIG. 5):
sysreg[L−1: 0]<={FLAG[0: n−1], sysreg[L−n: 0]}

In the case of inserting data from the low order in the register, as shown in FIG. 4, the contents of the register (sysreg) of L bits are shifted to left by n bits and the information (FLAG) of n bits is stored in the low order in the sysreg. The low order (L−n) bits in the sysreg are combined with the FLAG of n bits and the high order n bits in the sysreg are abandoned. In the case of inserting data from the high order of the register, as shown in FIG. 5, the contents of the register of L bits are shifted to right by the n bits and the FLAG of n bits is stored in the high order in the register. The FLAG of n bits is combined with the upper order (L−n) bits in the sysreg and the low order n bits in the sysreg are abandoned.

The exclusive circuit 113 as a circuit for storing the additional information into the general register (GR[1]) 114 will be described. FIG. 6 is a block diagram for use in describing the operation of the exclusive circuit in FIG. 3. The vector instruction according to the example combines the additional information elements (cc[3:0]) generated as the result of the operation in the combination circuit 1131, generates the additional information (CC), and stores the above information in the general register (GR[1]) 114. In order to store the additional information (CC) in the general register (GR[1]) 114, a register value is once read from the general register (GR[1]) 114 of the stored destination through a data path 115, shift processing is performed there by a shifter 1132, the additional information (CC) is inserted by a combination circuit 1133, and the value of the result is rewritten to the general register (GR[1]) 114 through a data path 116. The shifter 1132 shifts the data by a fixed value (for example, 4 bits) specified by “N” to a direction (right or left) specified by the “order”.

### Comparison Example

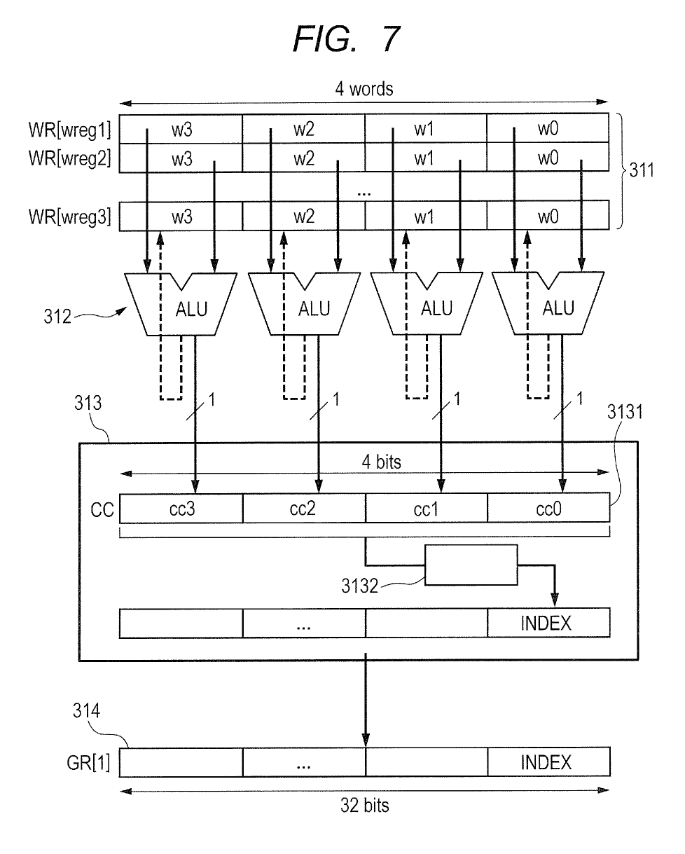

A technique examined by the inventor et al. prior to this disclosure (hereinafter, referred to as a comparison example) will be described. FIG. 7 is a block diagram for use in describing a vector instruction according to the comparison example. The vector instruction according to the comparison example is an instruction to execute an operation using two vector registers, write the operation result into the vector register, and output the information that supports the operation result (flag of the operation result and index obtained by processing the additional information of the comparison result), depending on the operation result; for example, the instruction as follows.

cmp3.N order, cond, wreg1, wreg2, wreg3

The vector instruction according to the comparison example is an instruction to compare each element between the wreg1 and the wreg2 with the contents of the vector register (wreg1) and the vector register (wreg2) regarded as character strings, store the result in the vector register (wreg3), simultaneously calculate the positions of the least and most significant bits that match a condition in the comparison result (additional information), and store the above in the general register (register implicitly specified, for example, GR[1]). In short, the vector instruction according to the comparison example stores the position of the first bit that matches the comparison condition (the positional information of the result) in the general register.

In order to search for data matching a certain condition from some array, the additional information of the comparison result is moved to the general register, hence to be converted into sequential processing, which requires a lot of time in search. More specifically, assume that a first algorithm for searching a position exceeding some boundary value from the arrays arranged in the decreasing or increasing order as follows is realized using the vector instruction according to the comparison example. In this disclosure, pseudo codes are used to describe the algorithm. The pseudo code is based on the C language. A sentence starting with the head of ‘//’ is a comment.

```
  for (i = 0; i < M; i++) {
    // array[ ] is an array to search, border is a boundary in the
search
    if (border > array[i]) return i;
  }
```

As shown in FIG. 7, the vector instruction according to the comparison example, with the contents of the vector register 311 regarded as a character string, makes a comparison using a vector arithmetic unit 312 and collects the result by a combination circuit 3131 of an exclusive circuit 313. Then, an index generating circuit 3132 of the exclusive circuit 313 calculates the position of the least significant bit having the bit 1 in the bit string of the additional information of the comparison result, to generate an index. The result is stored in the general register (GR[1]) 314. When there is no vector element that matches the comparison condition, a special numeric value is written in the general register (GR[1]) 314. Whether a word targeted for comparison exists in the vector register 311 or not is checked in such a way that; after executing the vector instruction according to the comparison example and then reading the general register (GR[1]) 314, it is checked whether the general register (GR[1]) 314 includes the special numeric value indicating there is no matched vector element. Based on the result, it is determined whether the next character string is read and compared in the vector register 311. This processing is performed by using the scalar instruction.

In this case of using the vector instruction according to the comparison example, since the information generated from the additional information of the comparison result is the index information, it is necessary to confirm whether the search succeeds or not referring to the general register in every comparison. In other words, when the vector instruction according to the comparison example can execute four comparisons at once (in the case of N=4), it checks as the algorithm whether the relevant value exists in the four arrays, once for every four. The vector instruction according to the comparison example, because of storing the index in the general register, needs the scalar instruction such as a comparison instruction and a branch instruction and includes the vector instruction and the scalar instruction in a mixed way, which disturbs the efficient use of a pipeline. When the vector instruction according to the comparison example is continuously executed without checking the contents of the general register, the contents of the general register are overwritten and the additional information of the comparison result in the past of the vector instruction is not succeeded.

Specifically, in the case of using the vector instruction according to the comparison example, it is necessary to go through the following steps.

Step 1: ANS=0. ANS is some general register indicating the index of a search word.

Step 2: execute the vector instruction according to the comparison example.

Step 3: check GR[1]=4. When GR[1]=4, after execution of ANS=ANS+GR[1], the operation moves to Step 4. When GR[1]≠4, the operation moves to Step 5. GR[1]=4 is the special numeric value, indicating there is no matched element.

Step 4: load the next character string in the vector register and move to Step 2.

Step 5: end. ANS=ANS+GR[1] becomes the index of the search word.

As mentioned above, the vector instruction according to the comparison example needs a lot of scalar instructions other than the vector instruction. The reason why so many instructions are required to search the index is that the vector instruction according to the comparison example does not succeed the additional information of the previous comparison result in the vector instruction and that the scalar instruction has to check the comparison result every time of executing a comparison in the vector instruction according to the comparison example.

In the vector instruction according to the comparison example, a stored destination of the index is defined as the general register; therefore, in order to read and check the result of the vector instruction, after the additional information of the index is written in the general register by the vector instruction, the additional information has to be read out from the general register and calculated by the scalar instruction, and as the result, queuing (pipeline install) occurs in order to solve Read After Write (RAW) hazard. According to this, the vector instruction according to the comparison example can speed up the comparison itself; however, when it is applied to the actual algorithm, the CPU pipeline cannot be used efficiently.

In the instruction according to the first example, the result can be inserted into the register for the number of the vector arithmetic units (N bits if N pieces of calculation can be performed simultaneously) per one instruction. When a comparison of the vector instruction is performed by the four vector arithmetic units in parallel, the comparison result of the total 4 bits consisting of 1 bit per every vector element is generated as the additional information. Here, the width of the general register (GR[1]) 114 is 32 bits. According to this, a comparison by the vector instruction can be continuously executed until filling the whole of the general register (GR[1]) 114 (finishing the comparison for 32 elements). In other words, when the number of the arithmetic units 112 is defined as 4 and the number of the bits of the general register is 32 bits, even when the vector instruction is executed for 32/4=8 times, the general register (GR[1]) never overflows with the result. While, the vector instruction according to the comparison example has to insert the scalar instruction for checking the operation result just after the execution of one instruction. The vector instruction according to the first example can search the arrays more efficiently than the vector instruction according to the comparison example because it can continuously execute the vector operation instruction.

As an example, the cases of making a comparison between

array A=[0, 4, 5, 10, 12, 8, 16, 27, 9, 1, 5, 8, 1, 0, 1, 1] and

array B=[1, 3, 7, 9, 15, 9, 20, 13, 11, 0, 3, 1, 9, 0, 0, 0] according to the vector instruction of the comparison example and according to the vector instruction of the example will be described. When the parallelism of the vector instruction is defined as 4, each array is loaded by every four elements to make a comparison. Here, the general register (GR[1]) as an additional information storing register has the initial value 0, and when A[i]<B[i], the flag (additional information element) is defined as 1; otherwise, the flag is defined as 0.

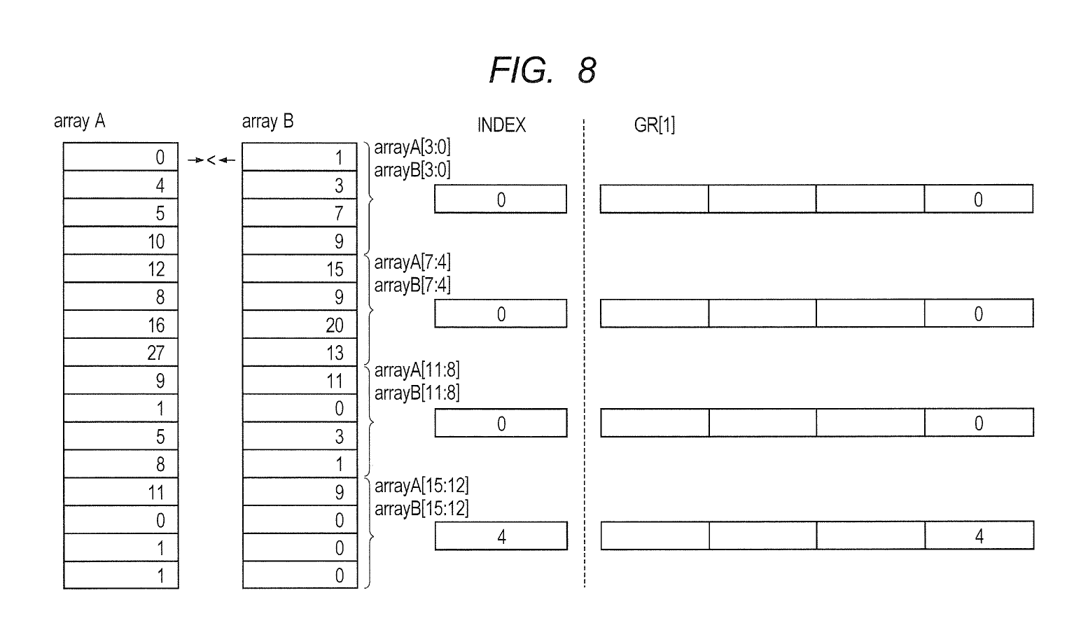

FIG. 8 is a view for use in describing the comparison operation in the continuous arrays using the vector instruction according to the comparison example. In the comparison using the vector instruction according to the comparison example, every four elements of the arrays A and B are loaded and the index that first matches the comparison condition is returned. Hereinafter, the detail will be described.

(1) The initial four elements, A=[0, 4, 5, 10] and B=[1, 3, 7, 9] are loaded in the vector registers to make a comparison. The first element is stored in the least significant word of the vector register and the fourth element is stored in the most significant word. Therefore, wreg1=[10, 5, 4, 0] and wreg2=[9, 7, 3, 1] and the least significant words match the comparison condition; as the comparison result, the additional information (index)=0.
(2) The comparison result is stored in the vector register like wreg 3=[0x0000_0000, 0xffff_ffff, 0x0000_0000, 0xffff_ffff]. Here, “0x” indicates hexadecimal number.
(3) The additional information (index) 0 is stored in the general register (GR[1]). Here, GR[1]=0000_0000_0000_0000.
(4) The above (1) to (3) will be repeated as for the next elements of the arrays A and B.

Since the second four elements are A=[12, 8, 16, 27] and B=[15, 9, 20, 13], wreg1=[27, 16, 8, 12] and wreg2=[13, 20, 9, 15] and the least significant words match the comparison condition; as the result, the index=0 and GR[1]=0x0000.

Since the third four elements are A=[9, 1, 5, 8] and B=[11, 0, 3, 1], wreg1=[8, 5, 1, 9] and wreg2=[1, 3, 0, 13] and the least significant words match the comparison condition; as the result, the index=0 and GR[1]=0x0000. Since the fourth four elements are A=[11, 0, 1, 1] and B=[9, 0, 0, 0], wreg1=[1, 1, 0, 11] and wreg2=[0, 0, 0, 9], and every word does not match the comparison condition; as the result, the index=4 and GR[1]=0x0004.

As mentioned above, the values of the additional information storing register (GR[1]) are always updated and the additional information of the previous comparison result does not remain. Therefore, just after the comparison by the vector operation, the value of the additional information storing register (GR[1]) has to be checked. In the vector instruction according to the comparison example, the index of the first element that matches the comparison condition is returned and the comparison result of the elements later than the above element matching the comparison condition is not reflected in the additional information storing register (GR[1]).

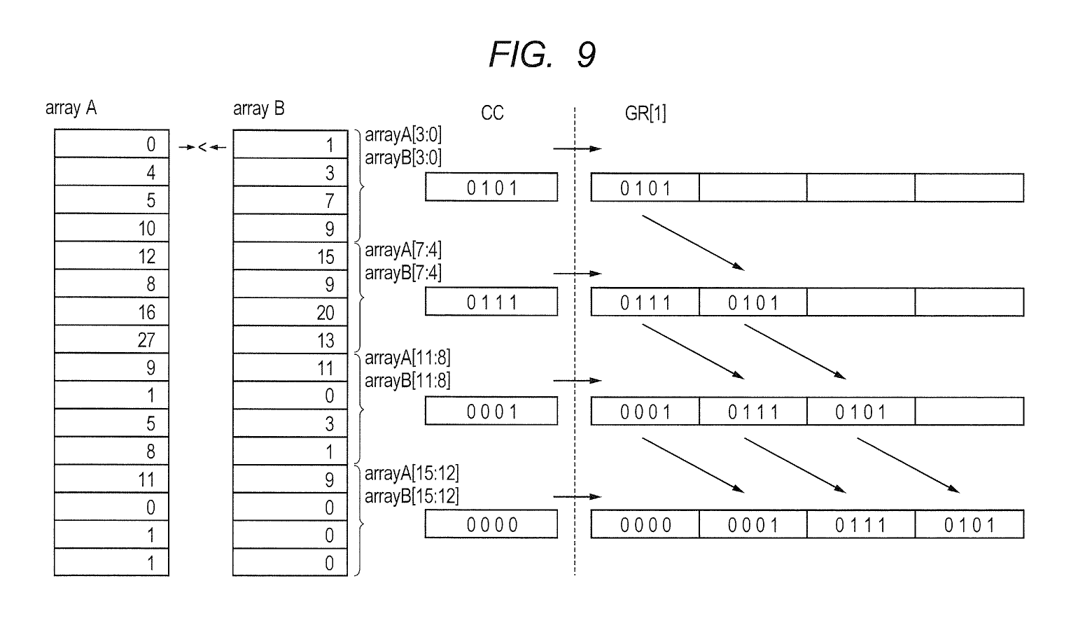

FIG. 9 is a view for use in describing the comparison operation in the continuous arrays using the vector instruction according to the first example. In the vector instruction according to the first example, the additional information as the comparison result is represented as a bit string and the result is downwardly or upwardly pushed into the general register (GR[1]) as the additional information storing register. Hereafter, the detail will be described.

(1) The initial four elements, A=[0, 4, 5, 10] and B=[1, 3, 7, 9] are loaded in the vector registers to make a comparison. The first element is stored in the least significant word of the vector register and the fourth element is stored in the most significant word. Therefore, wreg1=[10, 5, 4, 0] and wreg2=[9, 7, 3, 1]; as the comparison result, the additional information (flag)=[0, 1, 0, 1].
(2) The comparison result is stored in the vector register like wreg3=[0x0000_0000, 0xffff_ffff, 0x0000_0000, 0xffff_ffff]. Here, “0x” indicates hexadecimal number.
(3) The contents of the additional information storing register (GR[1]) are shifted to right and the flag of 4 bits [0, 1, 0, 1] is inserted in the GR[1]. The additional information is inserted from the high order of the GR[1] like GR[1]=0101_0000_0000_0000.
(4) The above (1) to (3) will be repeated as for the next elements of the arrays A and B.

Since the second four elements are A=[12, 8, 16, 27] and B=[15, 9, 20, 13], wreg1=[27, 16, 8, 12] and wreg2=[13, 20, 9, 15] and the flag=[0, 1, 1, 1]; as the result, GR[1]=0111_0101_0000_0000.

Since the third four elements are A=[9, 1, 5, 8] and B=[11, 0, 3, 1,], wreg1=[8, 5, 1, 9] and wreg2=[1, 3, 0, 13] and the flag=[0, 0, 0, 1]; as the result, GR[1]=0001_0111_0101_0000.

Since the fourth four elements are A=[11, 0, 1, 1] and B=[9, 0, 0, 0], wreg1=[1, 1, 0, 11] and wreg2=[0, 0, 0, 9] and the flag=[0, 0, 0, 0]; as the result, GR[1]=0000_0001_0111_0101.

According to the above operation, the value stored in the additional information storing register (GR[1]) is 0x1175 in the hexadecimal number, indicating the values of the additional information of the respective comparison result.

As mentioned above, in the vector instruction according to the first example, the additional information of the previous comparison result in the vector instruction is kept in the additional information storing register until it is pushed out due to the limit of the register width. Accordingly, even if the vector instruction is continuously performed, the additional information of the comparison result can be kept in the additional information storing register within its capacity range. The vector instruction according to the comparison example does not take over the additional information of the previous comparison result in the vector instruction but the vector instruction according to the first example can accumulate the additional information in the additional information storing register (GR[1]) 114 and take over the previous result in the vector instruction unless the additional information storing register (GR[1]) 114 overflows.

The vector instruction according to the first example generates the additional information separately from the operation result of the vector instruction and inserts the above information in the register different from the vector register; therefore, even when the vector instruction exceeds the number of the parallel data executable at once, it is possible to accumulate the result in the register only through the continuous execution of the vector instruction. It is not necessary to confirm the result of the flag and the like by the scalar instruction in every time of executing one of the vector instruction, differently from the comparison example, but the vector instruction can be executed until the additional information storing register gets full, and at the end, it is enough only to check the additional information storing register.

### Second Example

The vector instruction according to the first example needs reading and writing of the general register (GR[1]) in order to realize the insertion of the additional information (CC) by the general register (GR[1]) into a register and requires queuing of the general register. In other words, when the vector instruction according to the first example is continued, queuing occurs in order to solve the RAW hazard. Therefore, a vector instruction according to a second example is provided with an exclusive register and an exclusive circuit for storing the additional information.

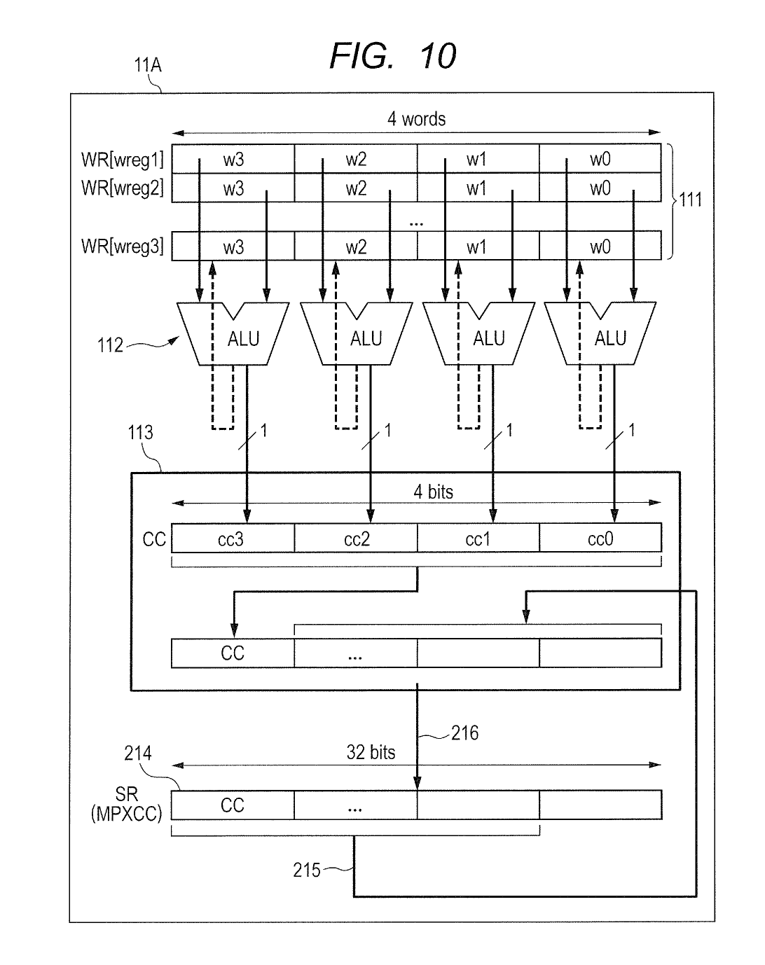

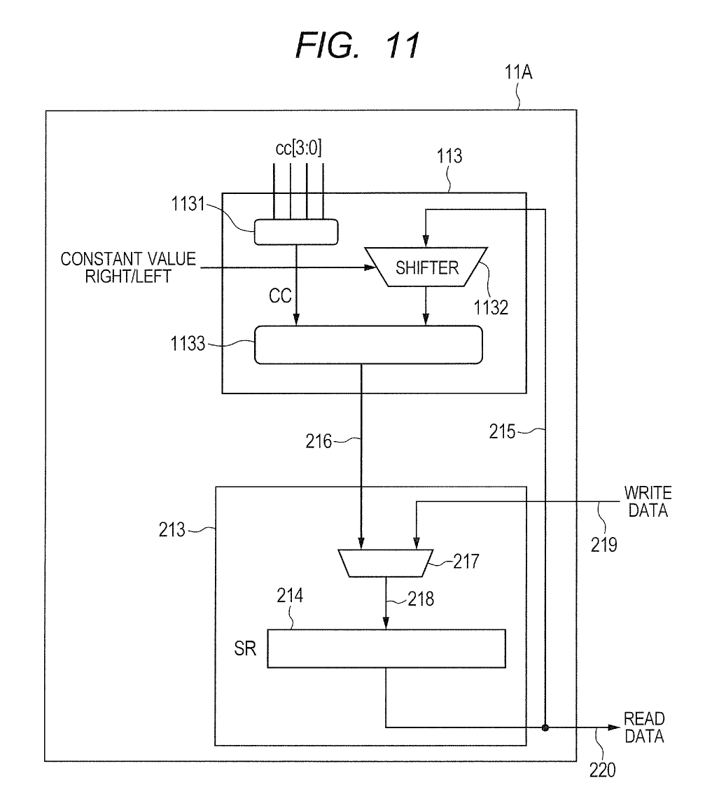

FIG. 10 is a block diagram for use in describing the vector instruction according to the second example. FIG. 11 is a block diagram for use in describing the exclusive register in FIG. 10. The semiconductor device executing the vector instruction according to the second example is the same as the semiconductor device according to the first example except for the structure of the vector operation unit. A vector operation unit 11A according to the second example is the same as the vector operation unit 11 according to the first example, except that an exclusive circuit 113 of the vector operation unit 11A is coupled to an exclusive circuit 213 and that the exclusive circuit 213 is coupled to the general register 16. The exclusive circuit 213 may be provided outside of the vector operation unit 11A. The exclusive circuit 213 includes an exclusive register (SR) 214 and a selector 217.

The vector instruction according to the second example is an instruction to perform the operation using two vector registers, write the operation result into the vector register, and output the additional information that supports the operation result, depending on the operation result; for example, the instruction as follows.

cmp2. N order, cond, wreg1, wreg2, wreg3

The vector instruction according to the second example compares the contents of the vector register (wreg1) with the contents of the vector register (wreg2), stores the result into the vector register (wreg3) and simultaneously stores the additional information into the exclusive register (SR) implicitly specified. The vector instruction according to the second example is the same as the vector instruction according to the first example, except for the stored destination of the additional information.

The vector instruction according to the second example combines the additional information elements (cc[3:0]) generated as the result of the operation by the combination circuit 1131 to generate the additional information (CC) and stores the same in the exclusive register (SR) 214. In order to store the additional information (CC) in the exclusive register (SR) 214, a register value is once read from the exclusive register (SR) 214 of the stored destination through a data path 215, shift processing is performed by the shifter 1132, the additional information (CC) is inserted by the combination circuit 1133, and the value of the result is rewritten in the exclusive register (SR) 214 through a data path 216. The shifter 1132 shifts the data by a fixed value (for example, 4 bits) specified by “N” to a direction (right or left) specified by the “order”.

Reading and writing of the exclusive register (SR) 214 is performed according to an instruction of reading and writing the exclusive register (an instruction of moving from the exclusive register to the general register, or an instruction of moving from the general register to the exclusive register), similarly to that of the system register 17. The exclusive register (SR) 214 includes a circuit of reading and writing the data having a 32 bit width in the same cycle. Therefore, the exclusive register (SR) 214 can perform the data reading through the data path 215 and the data writing through the data path 218 in parallel; therefore, the register can be updated without any RAW hazard when the vector instruction is continued.

In order to fetch and check the additional information, just after the vector instruction according to the second example, an instruction to move from the exclusive register to the general register is executed. The exclusive register (SR) 214 can perform the data reading through a data path 220 and the data writing through the data path 218 in parallel; therefore, the general register 16 can read the data without generating the RAM hazard. According to an instruction for moving from the general register to the exclusive register, the data is written in the exclusive register (SR) 214 through a data path 219, the selector 217, and the data path 218.

Next, a first algorithm for searching a position (index) exceeding some boundary from the arrays arranged in the increasing or decreasing order will be considered.

In order to realize the first algorithm, a non-vector instruction is used to compare the elements of the array one by one, or the vector instruction is used to compare a plurality of elements at once. A method of comparing the elements of the array one by one is a method of comparing values using the non-vector instruction (an instruction of basically using the general register without referring to the vector register, also referred to as a scalar instruction). On the other hand, when using the vector instruction, the values stored in the arrays [ ] can be compared with the border for every several values at once. The first algorithm can be changed to a second algorithm as shown in the below. For the sake of simplicity, assume that the element M of the array is the multiple of the parallel number N in the vector instruction.

```
  // when executing a simultaneous comparison for N words by the vector
operation instruction capable of simultaneous operation for the N words
  // store the value of border in all ways of the vector register vborder.
  vborder = {border, border, ..., border, border};
  for (i = 0;i < M / N; i++) {
    // take out a value from array and store it in vector register
    varray = {array[i*N+(N−1)], array[i*N+(N−2)], ...,
array[i*N+1], array[i*N+0]};
    // compare
    vresult = v_compare (vborder, array);
    }
```

In the above second algorithm, values can be compared with each other for every N words by using the vector instruction; however, it requires a lot of instructions in order to search a position where the additional information as the comparison result changes (a position where the value of the array becomes larger than the border). Generally, a third algorithm as shown in the below is taken.

```
  // when executing a simultaneous comparison for N words by the vector
operation instruction capable of simultaneous operation for the N words
  // store the value of border in all ways of the vector register vborder
  vborder = {border, border, ..., border, border};
        index = 0;
  for (i = 0;i < M / N; i++) {
        // take out the value from array and store it in vector register
        varray = {array[i*N+(N−1)], array[i*N+(N−2)], ...,
array[i*N+1], array[i*N+0]};
        // compare
          // compare each element between vborder and varray and store
the result in vresult
          // store flag of each vector element in flag (N bits)
        vresult = v_compare (vborder, varray, flag);
        // after executing the comparison for N words by the vector
compare instruction
        if (comparison result does not match the condition in all the
operation result (refer to flag)) {
              // when the corresponding vector element is not included
as the result of comparison, escape
              break;
      } else {
          index = index + N; // no hit in the compared vector strings
      }
  }
  // when the corresponding vector element is included, as the result
of comparison, examine which vector element matches the condition one
by one.
    for (i = 0; i < N; i++) {
      if (flag[i] == 1) {
            break;
      } else {
            index = index + 1;
      }
  }
```

As an example, the third algorithm for searching the index of the array exceeding the value 15 from the array A=[0,1,2,4, 5,7,8,10, 12,15,16,20, 22,25,30,31] in the increasing order will be described in the case of using the vector instruction according to the comparison example.

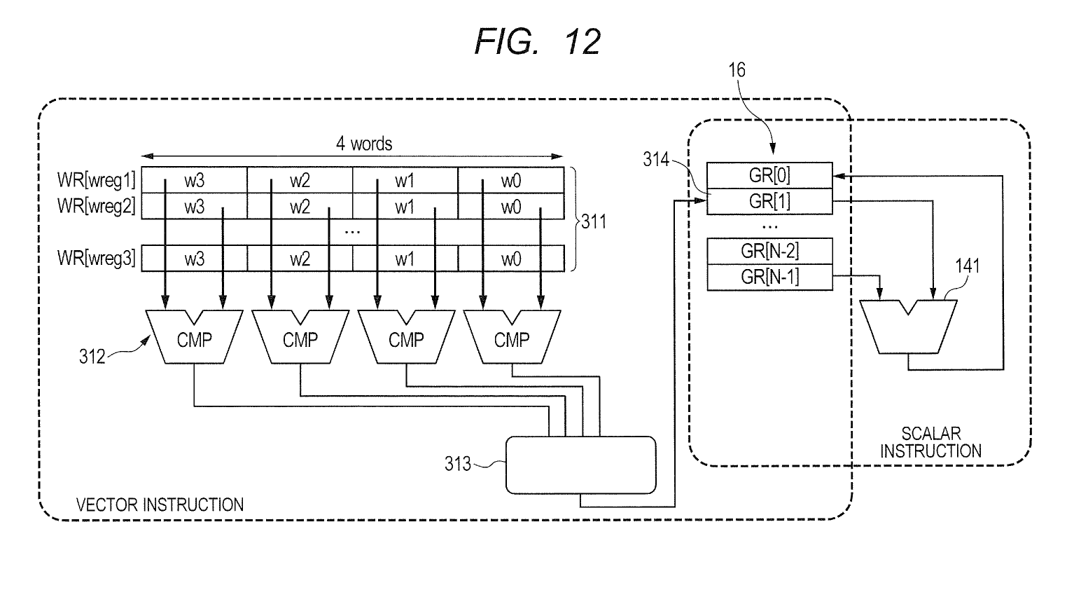

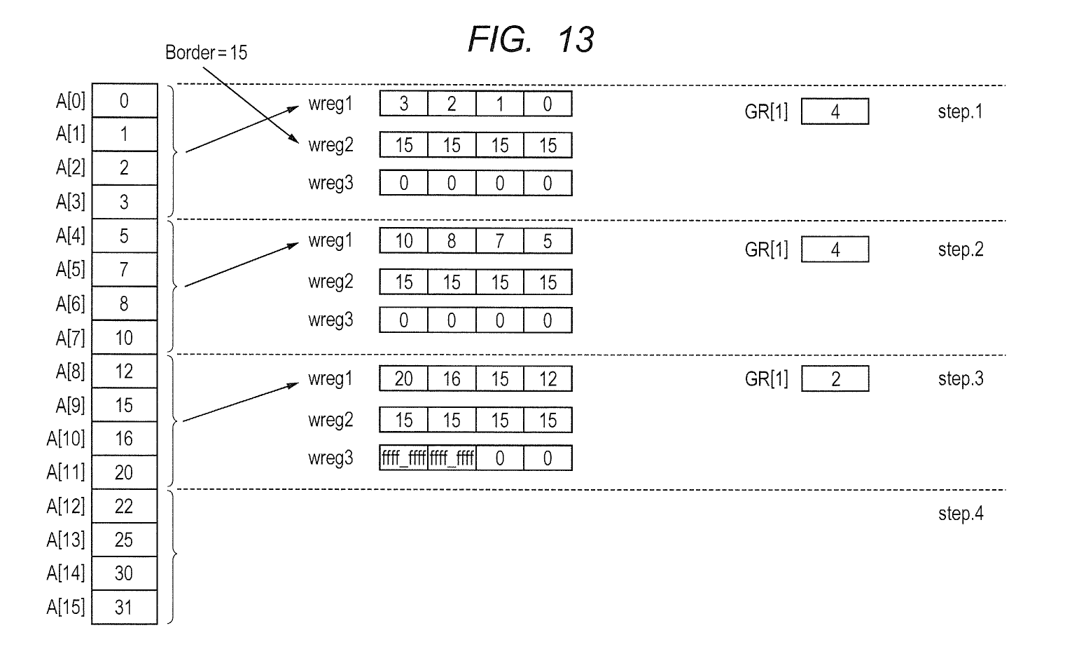

FIG. 12 is a view showing the structure of an instruction for executing an algorithm in the case of using the vector instruction according to the comparison example. FIG. 13 is a view showing the execution process in the case of executing the algorithm using the vector instruction according to the comparison example. In the vector instruction according to the comparison example, the index corresponding to the additional information as the comparison result is stored in the general register (GR[1]) 314. When the corresponding result dose not appear in the comparison result, the vector instruction according to the comparison example stores 4 as the index in the general register (GR[1]) 314. Hereinafter, the procedure in the case of using the vector instruction according to the comparison example will be described referring to FIG. 13. The parallelism of the vector instruction is defined as 4. The comparison instruction is to define 1 when A[i]>B[i]; otherwise, define 0.

Step 1:

```
if (GR[1]! = 4) {
  found a value exceeding border
} else {
    ANS = ANS + 4
}
```

(1) The value 15 of the border is stored in the vector register (wreg2); as the result, wreg2=[15, 15, 15, 15].
(2) Each value of the array A[3-0] is stored in the vector register (wreg1); as the result, wreg1=[4,2,1,0].
(3) The wreg1 is compared with the wreg2; as the result, the index=4 and GR=0000_0000_0000_0100.

Step 2:

```
if (GR[1]!=4) {
  found a value exceeding border
} else {
  ANS = ANS + 4
}
```

(1) Each value of the array A[7-4] is stored in the vector register (wreg1); as the result, wreg1=[10,8,7,5].
(2) The wreg1 is compared with the wreg2; as the result, the index=4 and GR=0000_0000_0000_0100.

Step 3:

```
if (GR[1]!=4) {
  found a value exceeding border
  ANS = ANS + GR[1] [symbol]     loop end
}
  ANS = ANS + GR[1];
}
```

(1) Each value of the array A[11-8] is stored in the vector register (wreg1); as the result, wreg1=[20,16,15,12].
(2) The wreg1 is compared with the wreg2; as the result, the index=2 and GR=0000_0000_0000_0010.

As for the array A[12-15] (Step 4), the vector instruction according to the comparison example is not executed.

The vector instruction according to the comparison example overwrites the additional information storing register (GR[1]) 314, without storing the previous result; therefore, it is necessary to insert a scalar instruction for checking whether or not a value exceeding the border is found in very execution of the vector instruction according to the comparison example. This check is performed by using the arithmetic unit 141 of the scalar operation unit. Further, the general register 16 is accessed alternatively by the vector instruction and the scalar instruction. The vector instruction and the scalar instruction (check of a value whether it exceeds 4 or not) have to be executed, thereby degrading the performance.

As mentioned above, although the vector instruction according to the comparison example can compare a plurality of values at once, thereafter, it has to search a position where the value matches the comparison condition from the index moved to the general register. In order to execute the third algorithm,

an instruction for comparing the contents of the general register (compare instruction) and

a branch instruction for branching based on the result of the compare instruction

are required, which does not mean the efficient use of the vector instruction cannot be used efficiently.

On the other hand, when using the vector instruction according to the second example, in the case of an instruction capable of the simultaneous operation for N words, the vector instruction according to the second example is performed for the number of times ceil (M/N); as the result, the M bit information is aligned in the additional information storing register like 11 . . . 10 . . . 000 in binary notation. By using an instruction for counting the number from the most significant order or the least significant order to the position 0/1, in the additional information storing register, the index of the boundary value can be calculated. Specifically, it is changed to a fourth algorithm as shown in the below. This is the case of using the exclusive register (SR) 214 capable of storing the additional information of the vector operation result for K bits, as the additional information storing register.

```
  vborder = {border, border, ..., border, border};
  for (i = 0; i < M/K; i++) {
    head_idx = i * K;
    for (j = 0; j < K/N; j++) {
      // take out a value from array and store it in vector
register.
      varray = {array[head_idx+(N−1)],
array[head_idx+(N−2)], ... array[head_idx+0]};
      // compare
      vresult = v_compare (vborder, array);
      head_idx = head_idx + N;
    }
    if (exclusive register ! =0x00) {
      goto finish;
    }
  }
  finish:
    // search_1_from_right is to search a position of bit having
1 sequentially from LSB
    // this function exists as instruction in many CPUs
    one_index = search_1_from_right (exclusive register);
    return head_ idx + one_index;
```

As an example, a fourth algorithm for searching the index of the array exceeding the value 15 from the array A=[0,1,2,4, 5,7,8,10, 12,15,16,20, 22,25,30,31] in the increasing order will be described in the case of using the vector instruction according to the second example. Here, assume that M=16, K=16, and N=4. Although the description was made with the exclusive register (SR) 214 of 32 bit width, the register of 16 bit width (K=16) is used for the sake of making the drawings and their description easy.

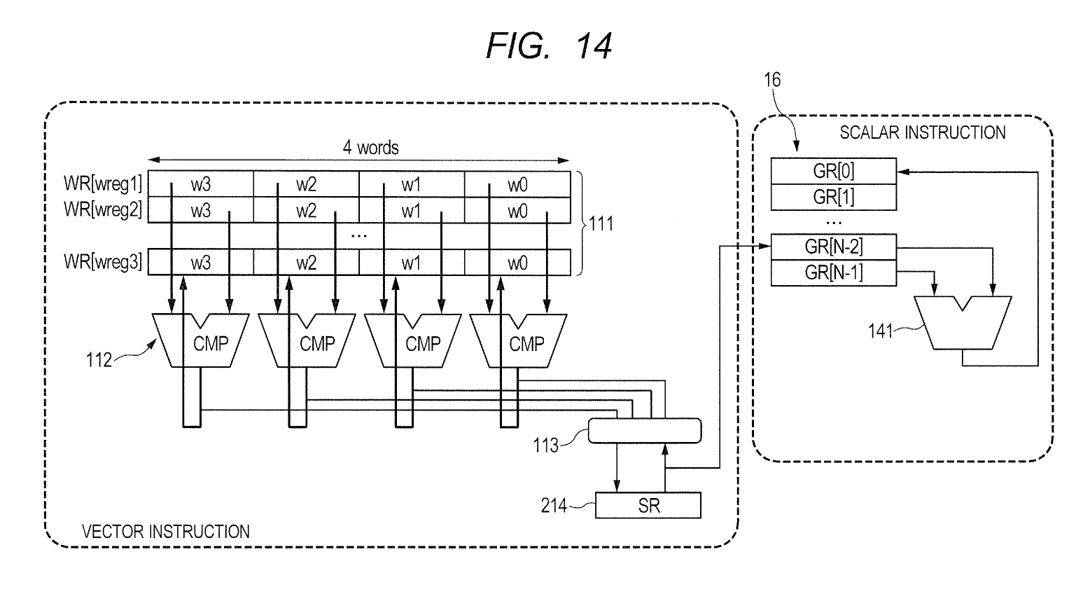

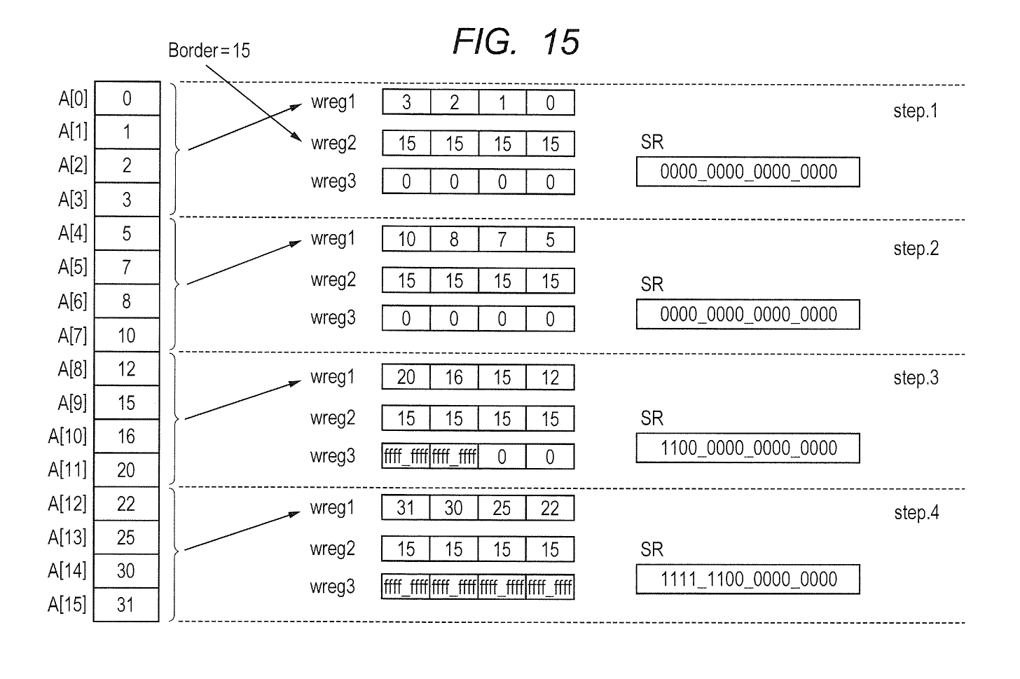

FIG. 14 is a view showing the structure of an instruction for executing an algorithm in the case of using the vector instruction according to the second example. FIG. 15 is a view showing the execution process in the case of executing the algorithm using the vector instruction according to the second example. In the innermost loop of the algorithm, nothing exists other than the vector instruction. This corresponds to the vector instruction surrounded by the dotted line of FIG. 14. The vector instruction can continuously perform the operation repeatedly (for K (=16) bits) until filling the exclusive register (SR) 214 which stores the additional information of the comparison result. Here, it is performed for the number of times K/N (=16/4=4). The vector instruction according to the second example does not have to move the result of the vector instruction to the general register 16 in the innermost loop but can execute the comparison continuously until the exclusive register (SR) 214 is filled with the bits of K (=16).

Upon completion of the comparison for K (=16) bits, the exclusive register (SR) 214 is estimated; when other than 0 is stored, it means that there exists the value exceeding the border. When 0 is stored in the exclusive register (SR) 214, it means that there is no value exceeding the border in the K (=16) arrays having been compared, hence to resume the comparison from the position of the next array (outermost loop). This corresponds to the scalar instruction surrounded by the dotted line of FIG. 14.

Hereinafter, the procedure in the case of using the vector instruction according to the second example will be described with reference to FIG. 15. The parallelism of the vector instruction is defined as 4. The comparison instruction is to define 1 when A[i]>B[i]; otherwise, define 0. The exclusive register SR=0.

Step 1:

(1) The value 15 of the border is stored in the vector register (wreg2) and it becomes wreg2=[15, 15, 15, 15].
(2) Each value of the array A[3-0] is stored in the vector register (wreg1) and it becomes wreg1=[4, 2, 1, 0].
(3) The wreg1 is compared with the wreg2 and it becomes the flag=[0, 0, 0, 0] and SR=0000_0000_0000_0000.

Step 2:

(1) Each value of the array A[7-4] is stored in the vector register (wreg1); as the result, wreg1=[10, 8, 7, 5].
(2) The wreg1 is compared with the wreg2; as the result, the flag=[0, 0, 0, 0] and SR=0000_0000_0000_0000.

Step 3:

(1) Each value of the array A[11-8] is stored in the vector register (wreg1); as the result, wreg1=[20, 16, 15, 12].
(2) The wreg1 is compared with the wreg2; as the result, the flag=[1, 1, 0, 0] and SR=1100_0000_0000_0000.

Step 4:

(1) Each value of the array A[15-12] is stored in the vector register (wreg1); as the result, wreg1=[31, 30, 25, 22].
(2) The wreg1 is compared with the wreg2; as the result, the flag=[1, 1, 1, 1] and SR=1111_1100_0000_0000.

In the above processing, a comparison result is inverted at the position exceeding the value 15 in the array A; as the result, it is found that the index of the array exceeding 15 is 10. This can be realized by one instruction; an instruction for moving the value of the exclusive register to the general register or an instruction of sequentially detecting the position having 1 from the lower bit of the general register.

In the above example, the innermost loop within the fourth algorithm is executed once; however, even when the size (M) of the array A is larger than 16, the values of the exclusive register are moved to the general register every time the exclusive register is filled with the size (K=16 bits), to check the additional information of the comparison result.

As mentioned above, by using the vector instruction according to the second example, the processing for moving the additional information to the general register is not necessary. In the innermost loop, a check of loop escape based on the comparison result becomes unnecessary.

From the above reason, the vector instruction according to the second example can efficiently use the vector comparison instruction, hence to improve the cycle performance. Further, the result of the vector comparison is stored in the exclusive register and the exclusive circuit for inserting data is assembled in the exclusive register; therefore, a reading operation for updating the values of the exclusive register is not necessary in every execution of the comparison instruction and the RAM hazard can be avoided in the exclusive register. The reading operation of the exclusive register becomes necessary only when checking whether the value of the exclusive register is 0 or not.

On the other hand, when using the vector instruction according to the second example, the values for the K bits are checked, hence to determine whether or not to escape from the loop; therefore, there is a tradeoff between the above and a method of determining whether or not to escape from the loop by comparing the words one by one using the scalar instruction when using the vector instruction according to the comparison example. When the array to search is small or the corresponding index is smaller than K, the scalar instruction can be used better to search the index sooner. However, when the size of the array is bigger or the index to search is larger, the vector instruction according to the second example in which comparison is made by every K bits, can improve the cycle performance.

The vector instruction according to the second example can speed up the algorithm for searching the position (index) exceeding some boundary, from the arrays arranged in the increasing or decreasing order.

As mentioned above, although the invention made by the inventor et al. has been described specifically based on the embodiments and the examples, it is needless to say that the invention is not restricted to the above but various modifications are possible.

For example, although the CPU and the memory included in the semiconductor device have been described by way of example, the memory may be included in another semiconductor device different from the semiconductor device including the CPU. Although the vector operation unit included in the CPU has been described by way of example, the vector operation unit may be provided outside of the CPU. Although the description has been made with the exclusive register of 32 bit width, it may be any other bit width such as 16 bit width or 64 bit width. Although the description has been made with the general register of 32 bit width, it may be any other bit width such as 16 bit width or 64 bit width. Although the description has been made with the vector register of 128 bit width, it may be any other bit width such as 64 bit width or 256 bit width. Although the description has been made with four arithmetic units of the vector operation unit, it may be any other number of the units such as eight.

### Embodiment

Appendixes as for the embodiment will be attached as follows.

### (Appendix 1)

A semiconductor device including a data processor capable of executing a vector instruction,

in which the data processor generates the additional information based on the operation result from the execution of the vector instruction,

the data processor includes an additional information storing register, and

the additional information storing register combines and stores bits indicating the additional information information in an empty portion resulting from the shift for the bits indicating the additional information according to the vector instruction.

### (Appendix 2)

In the semiconductor device as disclosed in (Appendix 1), the additional information storing register stores the bits indicating the additional information generated through several times of execution by the data processor.

What is claimed is:

1. A semiconductor device comprising a data processor capable of executing a vector instruction,
wherein the data processor includes a first and a second vector registers, and a general register or an exclusive register,
wherein the vector instruction is an instruction to calculate contents of the first vector register and contents of the second vector register for every element, combine additional information based on the calculated result for every element, shift contents of the general register or the exclusive register to right or left, insert the combined additional information in an empty portion resulting from the shift, and accumulate the additional information in the general register or the exclusive register.

2. The device according to claim 1,
wherein each of the first and second vector registers is capable of storing N pieces of elements, and
wherein the data processor is capable of executing an operation for the N pieces of the elements in parallel and generates N pieces of additional information.

3. The device according to claim 2,
wherein the vector instruction is an instruction to compare the contents of the first vector register and the contents of the second vector register with each other, and
wherein the additional information is a flag based on the comparison result; in case of agreement with a comparison condition, 1 or 0, while in case of disagreement with the comparison condition, 0 or 1.

4. The device according to claim 3,
wherein the vector instruction is capable of explicitly specifying the right or left shift, the comparison condition, and the number of elements calculated in parallel, and implicitly specifying the general register or the exclusive register.

5. The device according to claim 4, further comprising
a third vector register,
wherein the vector instruction stores the calculated result in the third register.

6. The device according to claim 5,
wherein N is from 1 to 4 and one element has a width of 32 bits.

7. The device according to claim 6,
wherein each of the first, second, and third vector registers has a width of 128 bits, the general register has a width of 32 bits, and the exclusive register has a width of 32 bits.

8. The device according to claim 2, further comprising:
a first combination circuit that combines the additional information;
a shift circuit that shifts the contents of the general register or the exclusive register to right or left, and
a second combination circuit that combines an output of the first combination circuit and an output of the shift circuit.

9. The device according to claim 8,
wherein the exclusive register is capable of data reading and writing in parallel.

10. The device according to claim 9,
wherein the data processor is capable of performing a scalar instruction, and
the scalar instruction includes an instruction for transferring the contents of the exclusive register to the general register and an instruction for detecting a first position including 1 or 0 from a lower bit or a higher bit of the general register.

11. A semiconductor device comprising:
a central processing unit capable of performing a vector instruction and a scalar instruction; and
a storing unit capable of storing the vector instruction and the scalar instruction,
wherein the central processing unit includes
first, second, and third vector registers,
a general register, and
an exclusive register,
wherein the vector instruction is an instruction to compare contents of the first vector register and contents of the second vector register with each other for every element, store the comparison result into the third register, combine the additional information based on the comparison result for every element, shift the contents of the general register or the exclusive register to right or left, insert the combined additional information in an empty portion resulting from the shift, and accumulate the additional information in the general register or the exclusive register.

12. The device according to claim 11,
wherein each of the first, second, and third vector registers is capable of storing N pieces of elements, and
wherein the central processing unit is capable of executing a comparison for the N pieces of elements in parallel and generates N pieces of additional information.

13. The device according to claim 11,
wherein N is from 1 to 4 and one element has a width of 32 bits.

14. The device according to claim 13,
wherein each of the first, second, and third vector registers has a width of 128 bits, the general register has a width of 32 bits, and the exclusive register has a width of 32 bits.

15. The device according to claim 12,
wherein the additional information is a flag based on the comparison result; in case of agreement with a comparison condition, 1 or 0, while in case of disagreement with the comparison condition, 0 or 1.

16. The device according to claim 15,
wherein the vector instruction is capable of explicitly specifying the right or left shift, the comparison condition, and the number of elements calculated in parallel, and implicitly specifying the general register or the exclusive register.

17. The device according to claim 16, further comprising:
a first combination circuit that combines the additional information;
a shift circuit that shifts the contents of the general register or the exclusive register to right or left, and
a second combination circuit that combines an output of the first combination circuit and an output of the shift circuit.

18. The device according to claim 17,
wherein the exclusive register is capable of data reading and writing in parallel.

19. The device according to claim 11,
wherein the scalar instruction includes an instruction for transferring the contents of the exclusive register to the general register and an instruction for detecting a first position including 1 or 0 from a lower bit or a higher bit of the general register.

20. The device according to claim 19,
wherein the central processing unit includes
a vector operation unit that executes the vector instruction, and
a scalar operation unit that executes the scalar instruction.
